(19) United States
(12) Patent Application Publication
(10) Pub. No.: US 2014/0146079 A1
(43) Pub. Date: May 29, 2014

(54) COLLABORATION METHOD FOR SPATIAL NAVIGATION

(71) Applicant: CALEX, INC., Kaohsiung (TW)

(72) Inventor: LI-DA HUANG, KAOHSIUNG (TW)

(73) Assignee: CALEX, INC., KAOHSIUNG (TW)

(21) Appl. No.: 13/687,580

(22) Filed: Nov. 28, 2012

(51) Int. Cl. G09G 5/377

(52) U.S. Cl. CPC G09G 5/377
USPC 345/629

(57) ABSTRACT

The invention provides a collaboration method for spatial navigation, including the steps of: providing a plurality of entities; building a self map; constructing a virtual self map, wherein the self map and at least one cognitive map received form at least one other entity are overlapped by combining at least one first possible match portion between the self map and at least one cognitive map when a confidence index of the cognitive map is no less than a threshold value; and constructing a virtual whole map, by repeating the step of constructing the virtual self map to form the virtual whole map for a specific space. Therefore, using the collaboration method for spatial navigation, the virtual whole map can be constructed in a short time, and the optimal virtual whole map can be obtained to improve the precision of the virtual whole map.

### BACKGROUND OF THE INVENTION

1. Field of the Invention

The present invention relates to a collaboration method, and more particularly to a collaboration method for spatial navigation.

2. Description of the Related Art

Spatial navigation is one of the main tasks for humans to survive. Finding the way home, tracing the prey, and avoiding the predators all depend on an accurate spatial navigation capability. In addition to the success of the spatial navigation performed by an individual, a group of individuals collaborate on spatial navigation through information sharing is the key to compete with the fierce environment. The communications usually are succinct, roughly described, and come with a many noises that result into errors. These errors are caused of various perceptions among the peers and different descriptions when relaying the information. In more formal terms, the signal-to-noise ratio (SNR) is low, and the priori probability (i.e., precondition, knowledge possessed by the individual) plays an important role as a bias when interpreting the received spatial information from peers.

### SUMMARY OF THE INVENTION

The present invention provides a collaboration method for spatial navigation. The collaboration method includes the steps of: providing a plurality of entities, wherein each entity communicates with the other entities, and each entity shares spatial navigation information with the other entities; building a self map for each entity; constructing a virtual self map for each entity, wherein the self map and at least one cognitive map received form at least one other entity are overlapped to be the virtual self map by combining at least one first possible match portion between the self map and at least one cognitive map when a confidence index of the cognitive map is no less than a threshold value; and constructing a virtual whole map, by repeating the step of constructing the virtual self map to form the virtual whole map for a specific space.

Therefore, using the collaboration method for spatial navigation of the invention, the virtual whole map can be constructed in a short time. Further, after a verifying step and a dynamically adjusting step, the optimal virtual whole map can be obtained to improve the precision of the virtual whole map.

### BRIEF DESCRIPTION OF THE DRAWINGS

FIG. 1 shows a schematic view of a self map of a first entity according to the present invention;

FIG. 2 shows a schematic view of a self map of a second entity according to the present invention;

FIG. 3 shows a schematic view of a first possible match portion according to the present invention;

FIG. 4 shows a schematic view of a second possible match portion according to the present invention;

FIG. 5 shows a schematic view of a virtual self map according to the present invention;

FIG. 6, it shows a schematic view of a first adjusted virtual self map according to the present invention;

FIG. 7 shows a schematic view of a virtual self map with a conflict point according to the present invention; and

FIG. 8 shows a schematic view of a second adjusted virtual self map according to the present invention.

### DETAILED DESCRIPTION OF THE INVENTION

Given an unknown space, the first challenge of a navigation task is to construct the cognitive map. According to the collaboration method for spatial navigation of the present invention, a plurality of entities are provided. Each entity communicates with the other entities, and each entity shares spatial navigation information with the other entities. The moving entity with information collection capability embedded with a given navigation task would explore this environment and gradually builds up a self map.

In this embodiment, there are assumptions on the collaboration method of the invention used in each entity. The collaboration method is designed to provide the best performance with minimum uncertainties in the described collaboration cognitive problem. Each entity behaves based on the same model. This model assumes:
1. Perfect memory: all the cognitive maps received are reserved perfectly within each entity.
2. Perfect match on its own cognitive map: Each entity maintains a self cognitive map, Self_Map denoted as G_s, which represents all the paths and locations visited by this entity itself. Once the Self_Map is built, this entity knows where exactly its location at this G_s , what it expects to see after any sequence of actions with the final location is limited within this G_s. Therefore, each entity knows if it is walking within or off G_s. If the entity walks off the G_s, the G_s is expanded and updated to cover the new locations and paths.

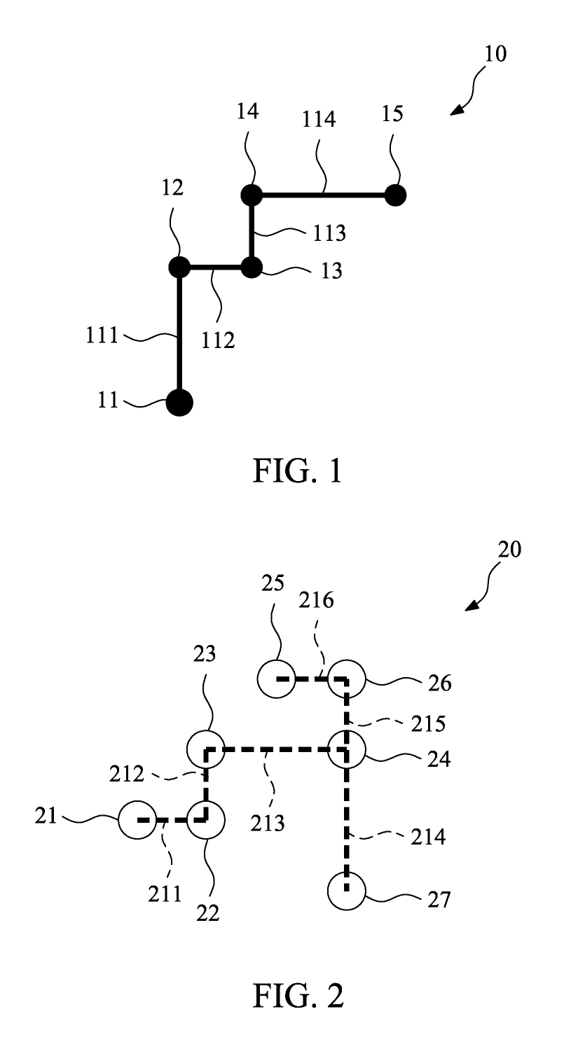

Referring to FIG. 1, it shows a schematic view of a self map of a first entity according to the present invention. The self map 10 of the first entity includes a plurality of nodes 11, 12, 13, 14 and 15 and a plurality of edges 111, 112, 113 and 114. The edges connect the nodes. Referring to FIG. 2, it shows a schematic view of a self map of a second entity according to the present invention. The self map 20 of the second entity includes a plurality of nodes 21, 22, 23, 24, 25, 26 and 27 and a plurality of edges 211, 212, 213, 214, 215 and 216. The edges connect the nodes. Each edge contains a number representing the distance between the connecting nodes and the orientation.

As stated in the above, each entity can communicate with the other entities, and each entity can share spatial navigation information with the other entities. Thus, the self map 20 of the second entity can be transmitted to the first entity, and the self map 10 of the first entity can be transmitted to the second entity so as to share spatial navigation information each other. For the first entity, the self map 20 of the second entity is a cognitive map, and can be used to overlap with the self map 10 of the first entity t.

Therefore, each entity maintains a set of cognitive maps received from the other entities.

Peer_Maps={G_i: G_i=received Self_Map from entity i}
Each entity calculates a confidence index of the received cognitive map G_i and links the cognitive map G_i to the self map G_s if two topologies and observation vectors matched on these connected nodes.

The confidence index would be calculated and assigned to each cognitive map G_i. The confidence index is based on the possible match portion between the cognitive map G_i and the self map G_s.

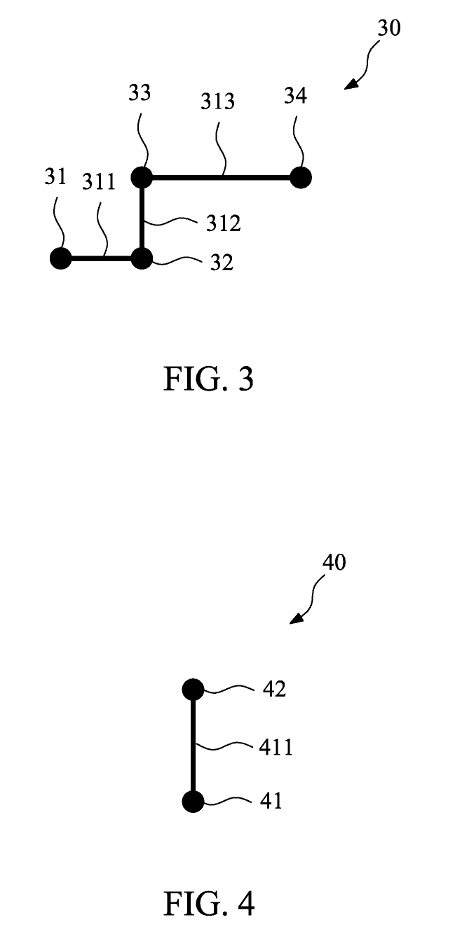

Referring to FIG. 3, it shows a schematic view of a first possible match portion according to the present invention. In this embodiment, the first possible match portion 30 includes a plurality of nodes 31, 32, 33 and 34 and a plurality of edges 311, 312 and 313. The first possible match portion 30 can be part of the self map 10 (referring to FIG. 1), for example, the nodes 12, 13, 14 and 15 and the edges 112, 113 and 114. Further, the first possible match portion 30 can be part of the self map 20 (referring to FIG. 2), for example, the nodes 21, 22, 23 and 24 and the edges 211, 212 and 213. That is, the first possible match portion 30 is a possible overlapped portion between the self map 10 and the self map 20 (the cognitive map).

Referring to FIG. 4, it shows a schematic view of a second possible match portion according to the present invention. In this embodiment, the second possible match portion 40 includes a plurality of nodes 41 and 42 and a edge 411. The second possible match portion 40 can be part of the self map 10 (referring to FIG. 1), for example, the nodes 11 and 12 and the edge 111. Further, the second possible match portion 40 can be part of the self map 20 (referring to FIG. 2), for example, the nodes 27 and 24 and the edge 214. That is, the second possible match portion 40 is a possible overlapped portion between the self map 10 and the self map 20 (the cognitive map). Compared with the first possible match portion 30 and the second possible match portion 40, the first possible match portion 30 is the best possible match portion, and can be used to link the self map 10 and the self map 20 firstly.

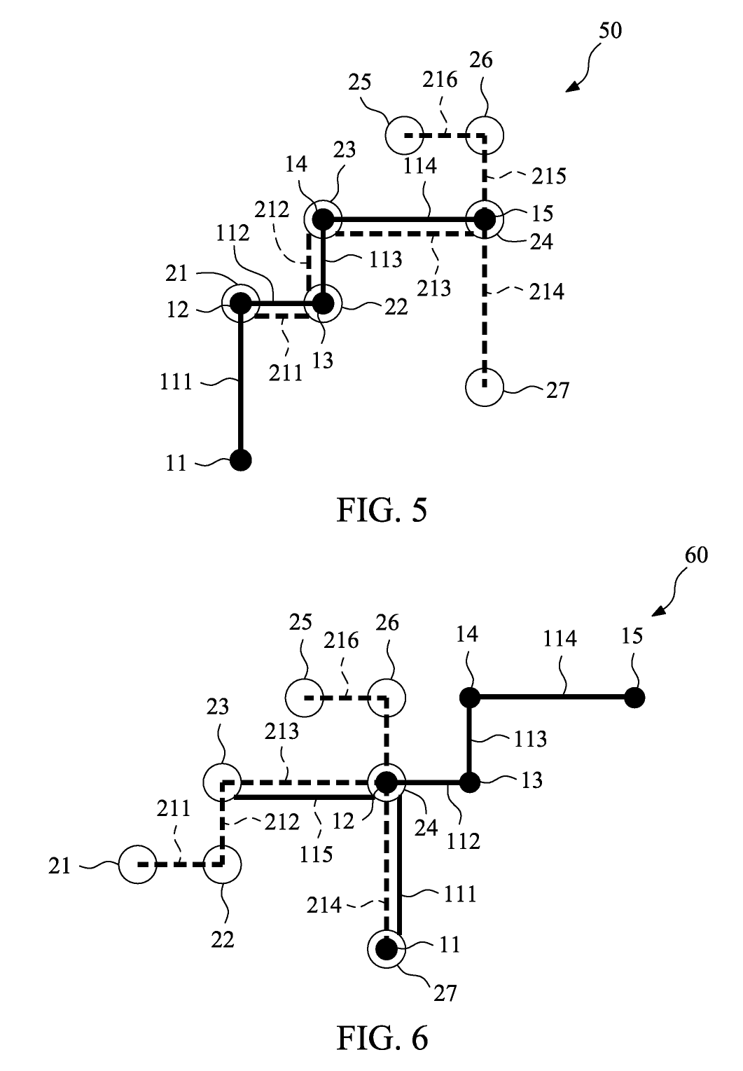

Referring to FIG. 5, it shows a schematic view of a virtual self map according to the present invention. For the first entity, if the confidence index of the cognitive map 20 from the second entity is no less than a threshold value, the self map 10 and the cognitive map 20 form the second entity are overlapped to be the virtual self map 50 by combining the first possible match portion 30 (referring to FIG. 3) between the self map 10 and the cognitive map 20. Therefore, the virtual self map 50 of the first entity includes the self map 10 and the cognitive map 20 by overlapping the first possible match portion. That is, the first entity can expand the self map 10 to the virtual self map 50 including the nodes and edges visited by the second entity.

By repeating the above step of constructing the virtual self map 50 of the first entity, the virtual self map 50 can be further expanded to form a virtual whole map for a specific space. Therefore, for the first entity, the virtual whole map can be constructed in a short time. Similarly, for the other entities, the virtual whole map can be constructed in a short time using the collaboration method of the invention.

According to the invention, the collaboration method for spatial navigation further includes a step of calculating the confidence index of the cognitive map, wherein the confidence index is increased when the at least one possible match portion increases, or the confidence index is reduced when the at least one possible match portion reduces. Further, the virtual self map has a confidence score according to the confidence index of each cognitive map from the other entity.

According to the invention, the collaboration method for spatial navigation further includes a step of verifying whether the virtual self map is correct by extending the self map to at least one node. Referring to FIG. 5, if the first entity walks toward the west direction from the node 12, the first entity finds the node 23 of the cognitive map should be on the west side of the node 12. Therefore, the virtual self map 50 is not correct after the verifying step.

The collaboration method for spatial navigation further includes a step of dynamically adjusting the virtual self map by overlapping the self map and at least one cognitive map received form at least one other entity by combining at least one second possible match portion between the self map and at least one cognitive map. Referring to FIG. 6, it shows a schematic view of a first adjusted virtual self map according to the present invention. In this embodiment, the virtual self map 50 is not correct after the verifying step. Then, the self map 10 and the cognitive map 20 form the second entity are overlapped again to form the first adjusted virtual self map 60 by combining the second possible match portion 40 (referring to FIG. 4) between the self map 10 and the cognitive map 20. Thus, the first adjusted virtual self map 60 of the first entity includes the self map 10 and the cognitive map 20 by overlapping the second possible match portion.

Therefore, after the verifying step and the dynamically adjusting step, the first adjusted virtual self map 60 can be the optimal virtual self map. And, after the repeating steps, the optimal virtual whole map can be obtained to improve the precision of the virtual whole map.

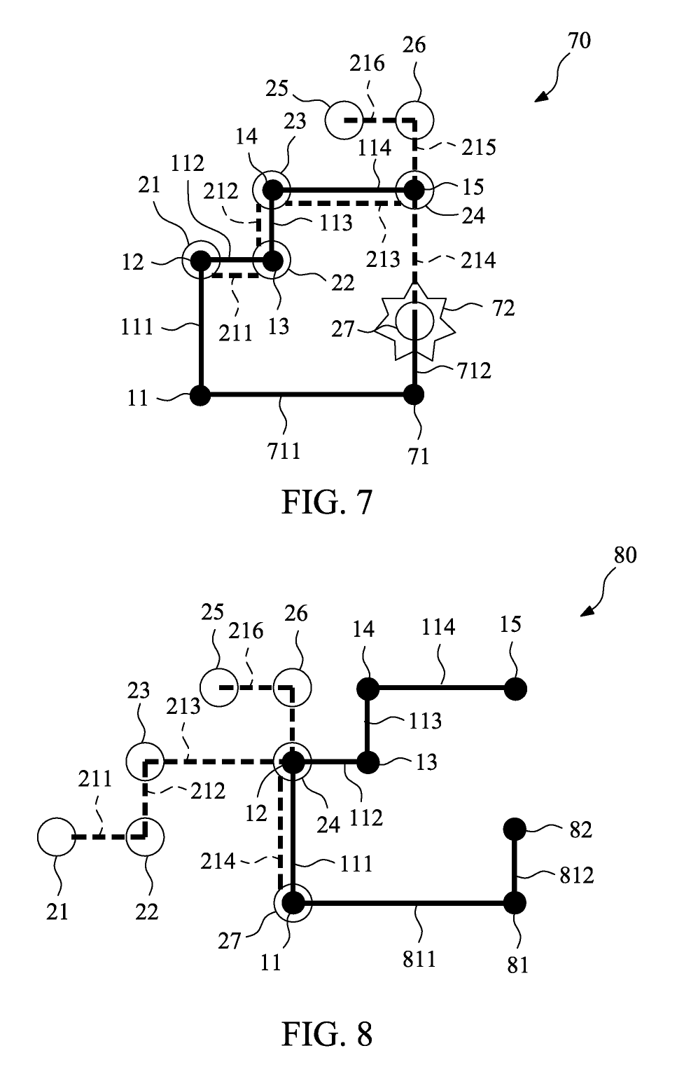

Referring to FIG. 7, it shows a schematic view of a virtual self map with a conflict point according to the present invention. The self map is extended to at least one node of the virtual self map, and the at least one node is a conflict point if the virtual self map is not correct. In this embodiment, if the first entity walks toward east direction from the node 11 to reach the node 71 then walks toward north direction to reach the node 72, the node 72 should be the node 27. However, the first entity finds the node 72 is not the node 27. The node 27 is a conflict point, thus the virtual self map 70 is not correct.

After finding the conflict point of the virtual self map, the collaboration method for spatial navigation further includes a step of dynamically adjusting the virtual self map by overlapping the self map and at least one cognitive map received form at least one other entity by combining at least one second possible match portion between the self map and at least one cognitive map. Referring to FIG. 8, it shows a schematic view of a second adjusted virtual self map according to the present invention. In this embodiment, the virtual self map 70 is not correct after finding the conflict point. Then, the self map 10 and the cognitive map 20 form the second entity are overlapped again to form the second adjusted virtual self map 80 by combining the second possible match portion 40 (referring to FIG. 4) between the self map 10 and the cognitive map 20. Thus, the second adjusted virtual self map 80 of the first entity includes the self map 10 and the cognitive map 20 by overlapping the second possible match portion.

Therefore, after the verifying step and the dynamically adjusting step, the second adjusted virtual self map 80 can be the optimal virtual self map. And, after the repeating steps and resolving all the conflict points from the virtual self map, the optimal virtual whole map can be obtained to improve the precision of the virtual whole map.

While several embodiments of the present invention have been illustrated and described, various modifications and improvements can be made by those skilled in the art. The embodiments of the present invention are therefore described in an illustrative but not in a restrictive sense. It is intended that the present invention should not be limited to the particular forms as illustrated and that all modifications which maintain the spirit and scope of the present invention are within the scope defined in the appended claims.

What is claimed is:

1. A collaboration method for spatial navigation, comprising the steps of:
providing a plurality of entities, wherein each entity communicates with the other entities, and each entity shares spatial navigation information with the other entities;
building a self map for each entity;
constructing a virtual self map for each entity, wherein the self map and at least one cognitive map received form at least one other entity are overlapped to be the virtual self map by combining at least one first possible match portion between the self map and at least one cognitive map when a confidence index of the cognitive map is no less than a threshold value; and
constructing a virtual whole map, by repeating the step of constructing the virtual self map to form the virtual whole map for a specific space.

2. The collaboration method for spatial navigation according to claim 1, wherein the confidence index is based on the at least one possible match portion.

3. The collaboration method for spatial navigation according to claim 1, further comprising a step of calculating the confidence index of the cognitive map, wherein the confidence index is increased when the at least one possible match portion increases, or the confidence index is reduced when the at least one possible match portion reduces.

4. The collaboration method for spatial navigation according to claim 1, wherein the self map and the virtual self map comprise a plurality of nodes and a plurality of edges, the edges connect the nodes.

5. The collaboration method for spatial navigation according to claim 4, further comprising a step of verifying whether the virtual self map is correct by extending the self map to at least one node.

6. The collaboration method for spatial navigation according to claim 5, further comprising a step of dynamically adjusting the virtual self map by overlapping the self map and at least one cognitive map received form at least one other entity by combining at least one second possible match portion between the self map and at least one cognitive map if the virtual self map is not correct.

7. The collaboration method for spatial navigation according to claim 5, wherein the self map is extended to at least one node of the virtual self map, and the at least one node is a conflict point if the virtual self map is not correct.

8. The collaboration method for spatial navigation according to claim 7, further comprising a step of dynamically adjusting the virtual self map by overlapping the self map and at least one cognitive map received form at least one other entity by combining at least one second possible match portion between the self map and at least one cognitive map.

9. The collaboration method for spatial navigation according to claim 1, further comprising a step of calculating a confidence score of the virtual self map according to the confidence index of at least one cognitive map from at least one other entity.
